(19) United States
(12) Patent Application Publication
(10) Pub. No.: US 2004/0022119 A1
(43) Pub. Date: Feb. 5, 2004

(54) Apparatus for preparing and dispensing road repair material

(76) Inventor: James McIntosh, Uckfield (GB)

Correspondence Address: William D. Lee, Jr., McNair Law Firm, P.A., P.O. Box 10827, Greenville, SC, 29603, US

(21) Appl. No.: 10/212,559

(22) Filed: Aug. 5, 2002

(51) Int. Cl. B28C 5/14

(52) U.S. Cl. 366/26; 366/64

(57) ABSTRACT

Apparatus for mixing and dispensing macadam material that includes a generally horizontal mixer chamber having a feed hopper above one end and a discharge chute depending downwardly from the other end. An elongate mixer rotor is included that has a plurality of vanes inclined to the axis of rotation of the rotor shaft is driven to urge aggregate from the end of the mixer chamber under the feed hopper to the end over the discharge chute, while agitating the aggregate to be mixed with binder applied from above. The discharge end of the mixer chamber can be raised and lowered in order to retard and accelerate the rate of movement of the agitated aggregate along the mixer chamber.

### FIELD OF THE INVENTION

The present invention relates to an apparatus for preparing a mixture of binder and aggregate for road repair use, for example a macadam material, and for dispensing it at the location of use, for example for filling potholes in a road surface.

### BACKGROUND OF THE INVENTION

In order to fill a pothole in a road surface it is known to apply macadam, which is a mixture of aggregate and a binder. Another form of a mixture of aggregate and binder is the so-called microasphalt, a slurry containing a fine aggregate for fine veneer coatings of a roadway surface. Conventionally the repair material such as macadam is prepared hot in a centralized plant and then transported to dispersed locations of use. The hot mixture needs to be used while soft and cannot be readily returned to the plant if too much is supplied for the repair required.

Accordingly, there is a need to avoid the centralized preparation of the mixture and avoid unnecessary waste of repair materials.

Therefore, it is an object of the present invention to provide an apparatus that can accept the dry aggregate and mix it with binder on site.

This and other objectives and advantages of the present invention will become apparent from the following more detailed description, taken in conjunction with the accompanying drawings, which illustrate the invention by way of example.

### SUMMARY OF THE INVENTION

The above objectives are accomplished according to the present invention by providing an apparatus for mixing and dispensing macadam material comprising an elongate mixer chamber; means for loading aggregate to a feed end of the mixer chamber; means for discharging aggregate from a discharge end of the mixer chamber; an agitator rotor within the chamber equipped with vanes spaced axially along the rotor to drive material axially along the chamber in a direction from the feed end towards said discharge end; and means for altering the inclination of the mixer chamber with respect to the horizontal.

In a further advantageous embodiment, the means for altering the inclination of the mixer chamber to the horizontal includes a pivot near the feed end of the mixer chamber and means for raising and lowering the discharge end of the mixer chamber. Advantageously, the apparatus includes means for rotating the agitator rotor comprises a hydraulic motor connected to a hydraulic pump as power source, and further including a hydraulic connection between the pump and a ram which serves as the means for raising and lowering the discharge end of the mixer chamber.

Preferably, the means for loading aggregate includes a feed hopper at the feed end of the mixer chamber, and a shutter between the feed hopper and the mixer chamber for allowing a predetermined batch of aggregate to be introduced into the mixer chamber when required. Advantageously, the apparatus includes means for rotating the agitator rotor comprises a hydraulic motor connected to a hydraulic pump as power source, and further including a hydraulic connection between the pump and a ram which serves as the means for raising and lowering the discharge end of the mixer chamber; and wherein the hydraulic pump is also connected to the ram to extend and retract the shutter between the feed hopper and the mixer chamber.

In a further advantageous embodiment, the apparatus includes means for reversing the direction of rotation of the agitator rotor for urging aggregate towards the feed end of the mixer chamber, when required.

In a further advantageous embodiment, the apparatus includes a pivot for swinging the mixer chamber about a vertical axis remote from the discharge end of the chamber, for allowing lateral movement of the discharge end of the mixer chamber.

In a further advantageous embodiment, the apparatus includes a vertically downwardly extending discharge chute at the discharge end of the mixer chamber for guiding the dispensed macadam material into a receiving container.

In a further advantageous embodiment, the apparatus includes a discharge opening at least the lower part of the end wall of the mixer chamber, and means for closing and opening said discharge opening. Preferably, the closing and opening means comprise a gate driven by a hydraulic actuator.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a side view, partly schematic, showing an embodiment of the apparatus according to the present invention;

FIG. 2 is an overhead view showing the embodiment of apparatus also illustrated in FIG. 1;

FIG. 3 is a side view of the mixing rotor shown schematically in FIG. 2;

FIG. 4 is a section taken on the line 4-4 of FIG. 2, with the outline of the discharge gate of FIG. 5 shown; and

FIG. 5 is a view corresponding to FIG. 1, but with an alternative dispensing outlet in the form of a slidable gate on the end wall.

### DETAILED DESCRIPTION OF A PREFERRED EMBODIMENT

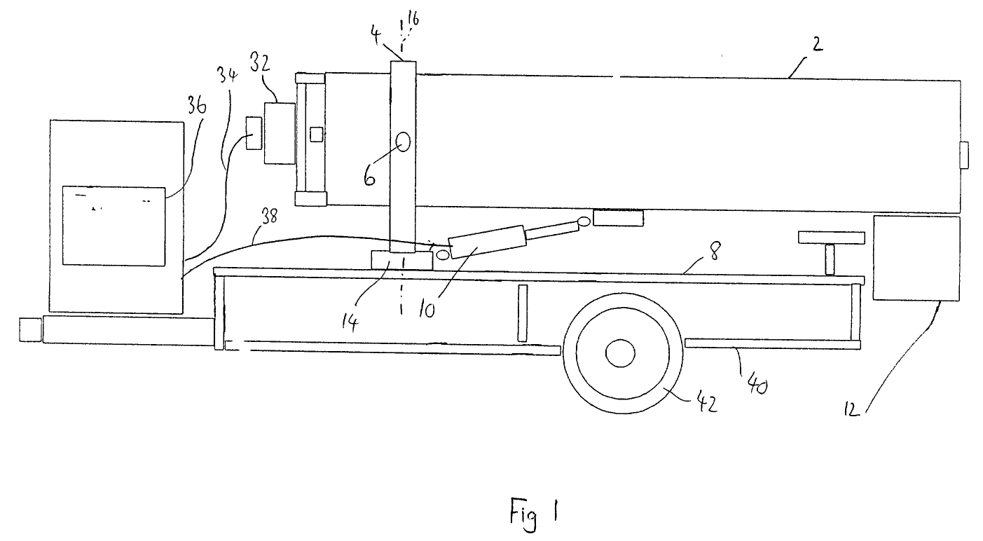

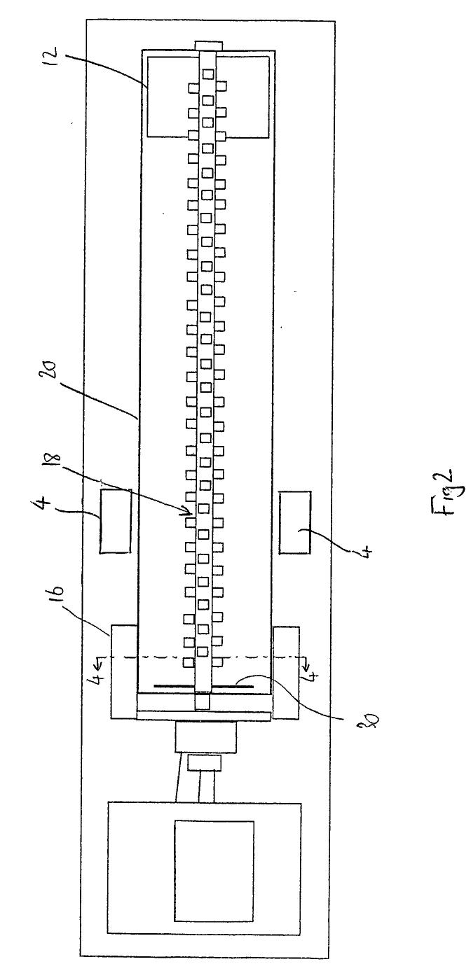

Referring now to the drawings, the invention will be described in more detail. Referring now to FIG. 1, the device comprises an elongate mixing chamber 2 in the form of a trough or drum mounted on a support bracket 4 by means of pivot stub shafts 6. Mounting bracket 4 is supported on a platform 8 by means of a turntable 14 which has a vertical axis of rotation so that the entire chamber can be rotated about the axis 16 in order to allow the discharge end to be swung from side to side to allow the material to be dispensed to one side or the other of the support platform 8. Although not shown in FIG. 1, there is a feed hopper (16 in FIG. 2) over the left-hand end of chamber 2, to the left of the line of the axis of stub shafts 6. Alternatively a binder in the form of an aqueous bitumen emulsion may be used.

At the right-hand end of mixer chamber 2 is a discharge chute 12 which allows the mixed material to drop vertically in a confined passage (preferably of the order of 40 cm×40 cm) so that the downward flow of mixed binder and aggregate into a receptacle such as a wheel barrow can be confined. Alternatively the material can be discharged straight onto a surface to be repaired using the macadam material.

The purpose of a ram 10 is to allow the inclination of the axis of the mixing chamber with respect to the horizontal to be changed, to either side of horizontal. By shortening ram 10, and thus lowering the discharge end of mixing chamber 2, it is possible to assist gravity discharge of material being mixed in chamber 2. On the other hand, by extending ram 10 and lifting the discharge end of the mixing chamber, it is possible to hinder discharge of the material being mixed in chamber 2 in order to prolong its residence time there and hence achieve more thorough mixing. The ability to raise and lower the discharge and of elongate mixing chamber 2 can be useful when working in locations where the ground slopes appreciably.

The material for which the present invention is intended to be used employs a cold setting binder, for example of resin composition such that it is possible to vary the rate of setting of the resin, for example in order to allow for either very rapid setting where the repair is to be subjected to traffic use very soon after it has been completed, or to delay setting so that it is possible to use a lot of small batches from the same main batch mixed in chamber 2, thereby allowing the apparatus to be repositioned over a succession of potholes or allowing a wheel barrow to be pushed around various different potholes after having been loaded with the mixed macadam material from the discharge end. It is envisaged that the resin used will be a cold-curing resin which is mixed cold with aggregate and hardens without the application of heat.

The overhead view shown in FIG. 2 illustrates feed hopper 16 and also shows mixer shaft 18 extending continuously from the feed end to the left-hand side of feed hopper 16 to the outlet end over discharge chute 12. In use the rotor rotates relative to non-rotatable chamber 2.

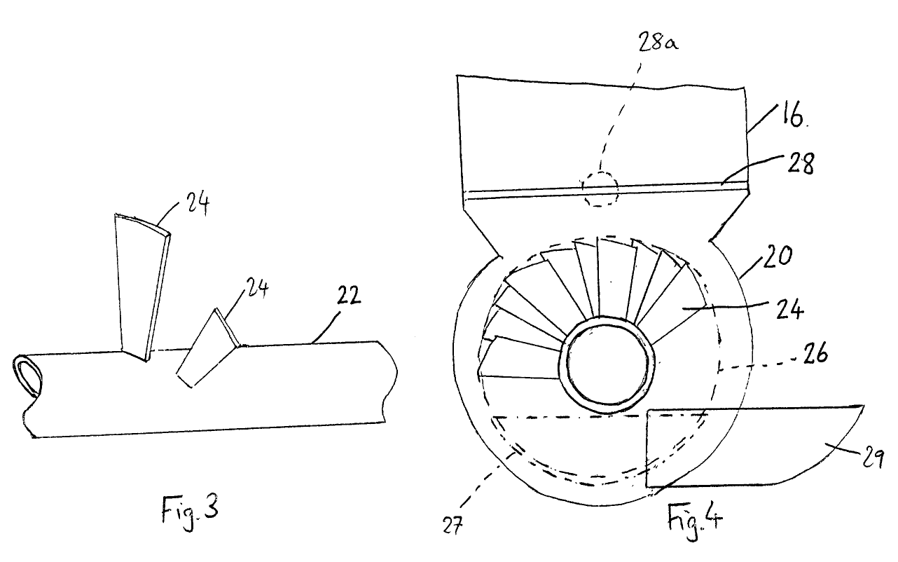

As shown in FIG. 3, the mixer shaft comprises a central tube 22 having mounted on it a succession of radially outwardly extending vanes 24 which are welded to the exterior of tube 22 so as to define an acute angle with the axis of the shaft. Although any suitable angle may be used and can be chosen by experiment, it has been found that angles in the range from 30° to 45° are particularly advantageous, and the value of 33° between the general plane of mixing vane 24 and the axis of tube 22 is a particularly preferred value. There are sufficient vanes 14, and their angle of indication is appropriately chosen, to ensure that during rotation of the rotor comprising shaft 18 and vanes 24 all zones of the longitudinal extent of chamber 2 will be swept. The preferred angle of 33° enables the material to be advanced positively along chamber 2 while it is being agitated.

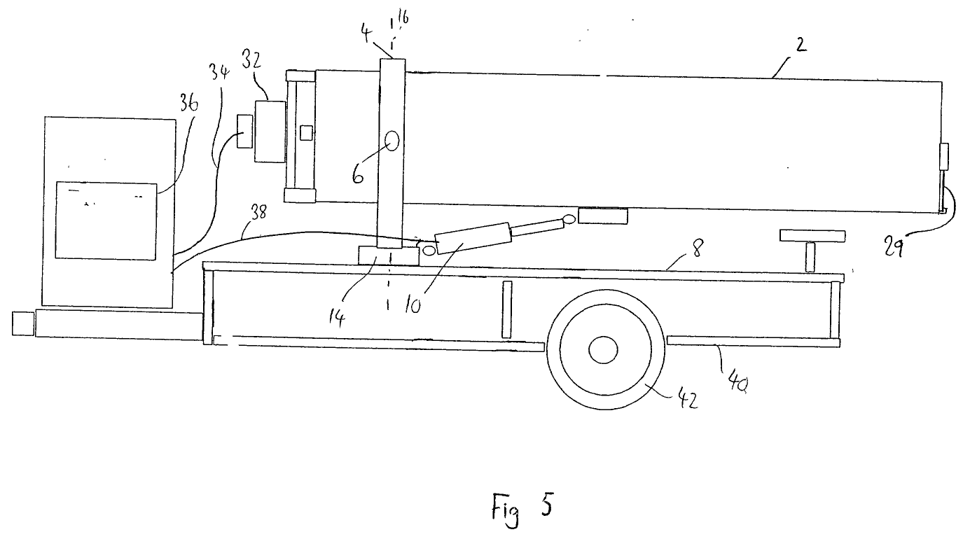

FIG. 4 shows a section taken on the line 4-4 of FIG. 2 and illustrates feed hopper 16 above the main cylindrical body of the mixing chamber, here in the form of a drum 20, and also shows the individual mixer vanes 24 defining a circular tip path 26. In practice, tip path 26 will be close to internal cylindrical wall of the drum, preferably within 2 mm of the drum wall, so as to avoid stone chippings of greater than 2 mm in the aggregate from becoming jammed between vane 24 and the drum wall. A standard aggregate has a range of particle sizes of chipping from 2 mm to 10 mm, mainly in the range 4 to 7 mm.

FIG. 4 also shows a horizontal shutter 28 which can be closed by means of a hydraulic ram (not shown) once a batch of aggregate and binder is already being mixed in drum 20, thereby allowing the next batch of aggregate to be pre-loaded into feed hopper 16. The precise ratio of resin binder to aggregate is known as a function of the nature of the binder used, and it is envisaged that feed hopper 16 will be of such a size as to accommodate enough material for a single batch of aggregate for loading into mixing drum 20. Then, once the already mixed batch has been dispensed for use in repairing a particular road location, and the operators are ready for the next batch to be mixed, the shutter 28 is withdrawn to allow that batch to fall into the feed end (the left-hand end in FIGS. 1 and 2) of mixing drum 20. Where dispensing the macadam into a wheel barrow, for example holding a charge of 200 kg of macadam material, it is preferable for the capacity of feed hopper 16 to be such that it holds approximately the same charge. It is then a simple matter merely to load the feed hopper with a quantity of aggregate such that when mixed with resin binder in the correct proportions that particular batch is known to be adequate to fill one barrow.

In order to avoid build-up of curing resin and aggregate on the end wall of mixing drum 20 at the feed end, the rotor shaft 22 carries a plurality of cleaning vanes 30 which are set exactly perpendicular to the axis of mixer shaft 22 and positioned close to the end wall of the discharge drum in order to sweep it clear of macadam material being mixed.

Mixer shaft 22 is rotated by a hydraulic motor 32 which is fed by way of a hydraulic hose 34 with hydraulic oil under pressure pumped by a hydraulic power unit 36. Power unit 36 also supplies hydraulic oil to ram 10 by way of a further hydraulic hose 38. Shutter 28 in FIG. 4 is also driven by a hydraulic ram (not shown) which will be powered by hydraulic power unit pump 36 shown in FIG. 1.

In the preferred embodiment of the mixing apparatus the pivoting of the mixer chamber about vertical axis 16 at turntable 14 is achieved manually in that the operator can then carefully swing vertical discharge chute 12 to one side to precisely the desired location. However, it may also be possible for the lateral movement to be powered by way of a further hydraulic motor or ram if desired.

The apparatus shown in FIG. 1 has the platform 8 mounted on a road-going trailer 40 having ground wheels 42 so as to be able to be towed behind a suitable tractor vehicle.

The preferred configuration for the mixing rotor is for the vanes to have a radial length which is approximately twice the diameter of the shaft. Furthermore, in order to maximize the extent to which the aggregate is moved along the mixing chamber while it is equally being agitated by rotation of the mixing rotor, there is a succession of individual vanes rather than a continuous screw and for the optimum gap between successive vanes on a helical path it is preferred for the gap between two successive vanes to be approximately 80% of the width of a vane. For example, where the vane is in the form of a plate 15.2 cm×6.4 cm (6 inches×2.5 inches) the gap between successive vanes is preferably of the order of 5.1 cm (2 inches).

Then follows the example of one cycle of use of the apparatus shown in FIGS. 1 and 4.

Firstly shutter 28 in FIG. 4 is in the closed position so as to prevent any material placed on the shutter from falling directly into the mixing chamber. An appropriate quantity of aggregate is poured into hopper 16 and then a bottle or other container enclosing the correct amount of liquid binder is available ready for operation of the apparatus.

Firstly the hydraulic pump is started and oil is pumped to mixer motor 32 to start rotation of the mixer shaft. When this is operating at the correct speed hydraulic oil is pumped from pump 36 to the ram (not shown) operating shutter 28 (FIG. 4) to withdraw shutter 28 to allow the waiting charge of aggregate to fall into the mixer chamber. In order to keep the aggregate at the inlet end of the mixer chamber, hydraulic oil will be pumped along hose 38 to ram 10 in order to extend the ram, either before shutter 28 is withdrawn or shortly thereafter, so that upward inclination of the discharge end of the chamber will retain the aggregate rotating in the feed end while the appropriate quantity of liquid binder is poured over it.

If desired there may be a spray bar for dispensing liquid binder not only at the inlet end below the feed hopper but also over at least part of the axial extent of the mixer chamber from the feed end towards the discharge end.

Accelerating or retardant agents may be added, as appropriate, to control the rate of setting of the binder when mixed with the aggregate.

In case, despite upward inclination of the mixer chamber towards the discharge end, the aggregate nevertheless moves away from the feed end under the influence of the inclined mixer vanes it is of course possible to reverse the direction of rotation of the mixer shaft so as to pull the aggregate back into the feed end where more of it will be contacted very quickly by the incoming liquid binder.

Depending on the rate of setting of the binder used, the rotation continues in this “feed end” configuration for a suitable interval before the dispensing is required. Then, with the rotor shaft rotating in a direction which urges the aggregate and the binder towards discharge chute 12, ram 10 is retracted in order to lower discharge chute 12 and facilitate passage of the macadam to discharge chute 12 for dispensing.

Meanwhile, as soon as the binder has been poured in through the open feed hopper, shutter 28 is again extended to blank off the feed hopper from the mixer chamber and thus to allow the next charge of aggregate to be loaded into the feed hopper ready for subsequent use.

As soon as dispensing at a particular location is complete the trailer can be pulled by a tractor to a new location where the mixing and dispensing operation can be carried out again.

FIG. 5 corresponds greatly to the disclosure of FIG. 1, but shows a modified version of the dispensing arrangement. Whereas in FIG. 1 there is a discharge chute 12 underneath an opening in the underside of mixer chamber 2, the arrangement in FIG. 5 uses a discharge opening in the end wall of chamber 2 but closed by a gate or shutter 29. FIG. 4 illustrates the arrangement of this shutter 29 and the outline of the discharge opening in the end wall of mixer chamber 2.

The more positive control of the discharge of the mixed material using slidable gate 29 of FIGS. 4 and 5 gives a much more controllable dispensing action and is particularly suitable where small potholes are to be filled and therefore only a small amount of material is to be dispensed each time. Furthermore, this provides a more positive controlling action when working with the so-called microasphalt which has a much finer particle size of aggregate than is conventional with macadam. With microasphalt the slurry including the fine aggregate particles would tend to pour over the discharge opening and into the discharge chute 12 of the FIG. I embodiment whereas the positive closing of the discharge opening 27 in the FIG. 4 embodiment avoids this risk.

Mention has been made above of the use of a slurry mix or microasphalt, another possible use for the slurry would be when dispensing color mixes of asphalt which are traditionally more readily flowable than is macadam.

With the embodiment of FIGS. 4 and 5 it is advisable to incorporate at the discharge end of the mixing shaft 22 a further set of cleaning blades such as blades 30 of FIG. 2 at the inlet end, so as to keep clear the inside end wall of the mixer chamber in the discharge region where it would be a disadvantage to allow a build up of mixed binder and resin to interfere with the movement of the gate 29.

Although not illustrated in the drawings, the gate 29 will be driven for its horizontal opening and closing movement preferably by another hydraulic actuator fed from the power unit 36 shown in FIGS. 1 and 5.

While a preferred embodiment of the invention has been described using specific terms, such description is for illustrative purposes only, and it is to be understood that changes and variations may be made without departing from the spirit or scope of the following claims.

What is claimed is:

1. Apparatus for mixing and dispensing macadam material, comprising:
an elongate mixer chamber;
means for loading aggregate to a feed end of said mixer chamber;
means for discharging aggregate from a discharge end of said mixer chamber;
an agitator rotor within said chamber equipped with vanes spaced axially along the rotor to drive material axially along the chamber in a direction from said feed end towards said discharge end; and
means for altering the inclination of the mixer chamber with respect to the horizontal.

2. Apparatus according to claim 1, wherein said means for altering the inclination of the mixer chamber to the horizontal includes a pivot near the feed end of the mixer chamber and means for raising and lowering the discharge end of the mixer chamber.

3. Apparatus according to claim 2, including means for rotating the agitator rotor comprises a hydraulic motor connected to a hydraulic pump as power source, and further including a hydraulic connection between said pump and a ram which serves as said means for raising and lowering the discharge end of the mixer chamber.

4. Apparatus according to claim 1, wherein said means for loading aggregate includes a feed hopper at the feed end of said mixer chamber, and a shutter between the feed hopper and the mixer chamber for allowing a predetermined batch of aggregate to be introduced into the mixer chamber when required.

5. Apparatus according to claim 4 including means for rotating the agitator rotor comprises a hydraulic motor connected to a hydraulic pump as power source, and further including a hydraulic connection between said pump and a ram which serves as said means for raising and lowering the discharge end of the mixer chamber; and wherein said hydraulic pump is also connected to said ram to extend and retract the shutter between the feed hopper and the mixer chamber.

6. Apparatus according to claim 1, including means for reversing the direction of rotation of the agitator rotor for urging aggregate towards the feed end of the mixer chamber, when required.

7. Apparatus according to claim 1, and including a pivot for swinging the mixer chamber about a vertical axis remote from the discharge end of the chamber, for allowing lateral movement of the discharge end of the mixer chamber.

8. Apparatus according to claim 1, and including a vertically downwardly extending discharge chute at the discharge end of the mixer chamber for guiding the dispensed macadam material into a receiving container.

9. Apparatus according to claim 1, including a discharge opening at least the lower part of the end wall of the mixer chamber, and means for closing and opening said discharge opening.

10. Apparatus according to claim 9, wherein said closing and opening means comprise a gate driven by a hydraulic actuator.
